(19) United States
(12) Patent Application Publication
(10) Pub. No.: US 2026/0195220 A1
(43) Pub. Date: Jul. 9, 2026

(54) RECOVERY OF CONTAINER LAYERS THAT ARE IN ERROR DUE TO DEPENDENCIES

(71) Applicant: International Business Machines Corporation, Armonk, NY (US)

(72) Inventors: Hao Wu, Beijing (CN); Xiao Ling Chen, Beijing (CN); Wen Ji Huang, Beijing (CN); Wen Qi WQ Ye, Beijing (CN)

(21) Appl. No.: 19/013,442

(22) Filed: Jan. 8, 2025

(51) Int. Cl. G06F 11/14; G06F 8/658

(52) U.S. Cl. CPC G06F 11/1433; G06F 8/658; G06F 11/1435

(57) ABSTRACT

A computer-implemented method that recovers container layers that are in error due to dependencies is provided. A number of processor units download a container image from an image repository; deploy the container image as a container at a local graph; identify an image layer of the container image of the container as having a patch in error layer recovery on dependency; and perform relocating, rebasing, and recovering the image layer having the patch in error layer recovery on dependency without redeploying the container image at the local graph or restarting a service running the container. According to other illustrative embodiments, a computer system and computer program product for recovery of container layers that are in error due to dependencies are provided.

### BACKGROUND

The present disclosure relates generally to methods, systems and computer program products to recover container layers, and more specifically to recovery of container layers that are in error due to dependencies.

Containers provide an application layer approach to virtualization. A container packages together code and its dependencies, and the container can be run on a physical processing system. Multiple containers can be run on the same physical processing system. This approach uses less resources than a virtual machine approach to virtualization.

Based on current popular container technology, when committing an image, all the contents of the image layers are packaged and pushed to the repository in the form of an image. When pulling an image from the repository, there is a need to download all the contents of the specified image layers and all parent layers to the local. In other words, all layers of the image are uploaded or downloaded.

After a product is released, there is a need to deliver patches continuously for the service work. Unfortunately, a few months or longer time after patches are released, there can be reports that some of them were in error. Consequently, it is impossible for users to remove the patch in error immediately if a higher version is used in their product environment.

For example, to fix an issue found on an old layer (i.e. L3), a fix patch is delivered on a newer layer (i.e. L5) of the image. Unbeknownst at the time, the fixes on L5 in this example trigger other errors (this can be termed Patch in Error). In the meantime, higher versions are delivered and used so that in this example the top layer is L8 (where layer L5 with patch in error is followed by L6 and L7). In this example there are two options for such a customer. Either, waiting for the availability of L5's fix(es) which may be several months later, or, redeploying to one of the lower safe versions (i.e. the version L4 or lower) and at least temporarily abandoning the new functions or fixes on the higher layers (i.e. L5 & L6 & L7 & L8).

### SUMMARY

According to one illustrative embodiment, a computer-implemented method for recovering layers of a container is provided. A number of processor units download a container image from an image repository; deploy the container image as a container at a local graph; identify an image layer of the container image of the container as having a patch in error layer recovery on dependency; and perform relocating, rebasing, and recovering the image layer having the patch in error layer recovery on dependency without redeploying the container image at the local graph or restarting a service running the container. According to other illustrative embodiments, a computer system and computer program product for recovering layers of a container are provided.

### BRIEF DESCRIPTION OF THE DRAWINGS

FIG. 1 is a block diagram of a computing environment.

FIG. 2 is a block diagram of container layers.

FIG. 3 is a block diagram of container layers.

FIG. 4 is a block diagram of container layers.

FIG. 5 is a block diagram of container layers.

FIG. 6 is a block diagram of container layers.

FIG. 7 is a block diagram of a computer system architecture to recover container layers in error due to dependencies.

FIG. 8 is a block diagram of a computer system architecture to recover container layers in error due to dependencies.

FIG. 9 is a block diagram of a container of an online patch in error layer recovery on dependency module.

FIG. 10 is a block diagram of an online patch in error layer recovery on dependency module.

FIG. 11 is a block diagram of a sequence.

FIG. 12 is a block diagram of an online patch in error layer recovery on dependency module.

FIG. 13 is a block diagram of a sequence.

FIG. 14 is a block diagram of an online patch in error layer recovery on dependency module.

FIG. 15 is a block diagram of a sequence.

FIG. 16 is a block diagram of an online patch in error layer recovery on dependency module.

FIG. 17 is a block diagram of a container of an online patch in error layer recovery on dependency module.

FIG. 18 is a flow chart of a process.

FIG. 19 is a block diagram of a data processing system.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

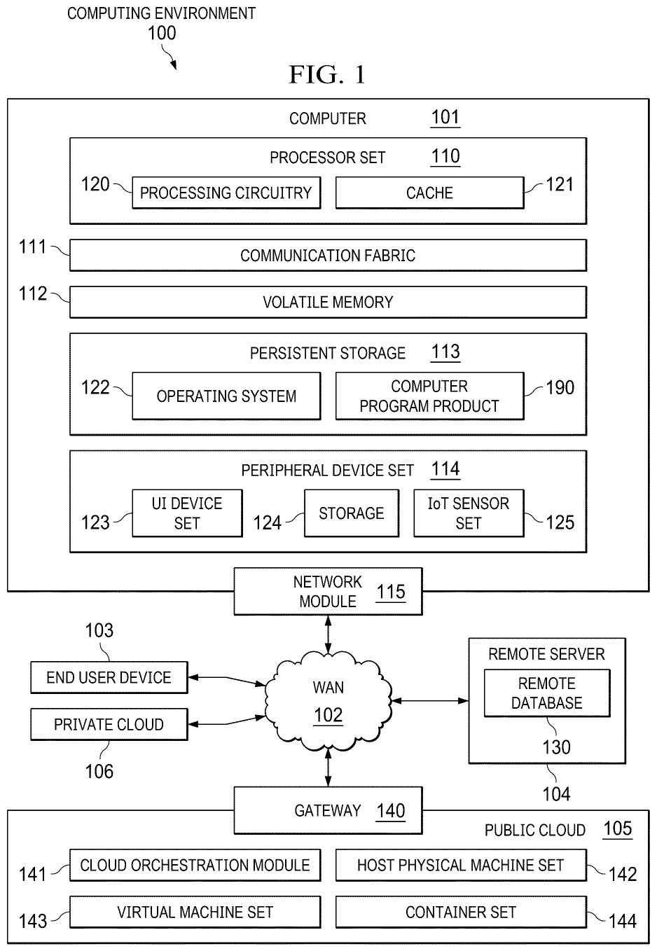

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as recovery of container layers that are in error due to dependencies 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and computer program product 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile sequestering device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in computer program product 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in computer program product 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Embodiments of this disclosure provide an intelligent and automatic method to ensure the better use of product capabilities, automation and resiliency insights by recovering the layer with patch in error with file dependencies on local image, or exploited containers, by excluding precisely the files which trigger the error. Embodiments can be achieved by introducing a new attribute diff-recovery under cacheID directory and relocating diff-relocation to diff-recovery, to help users promote the robustness of the enterprise-level production environments as soon as possible and minimize the security vulnerability exposure as much as possible.

This approach allows users to recover the layer with patch in error on local image more accurately without waiting a long time for the fixes available or redeploy exploited containers on a customer's environment especially the product environment. The approach is transparent to both the developers of the image and the end users.

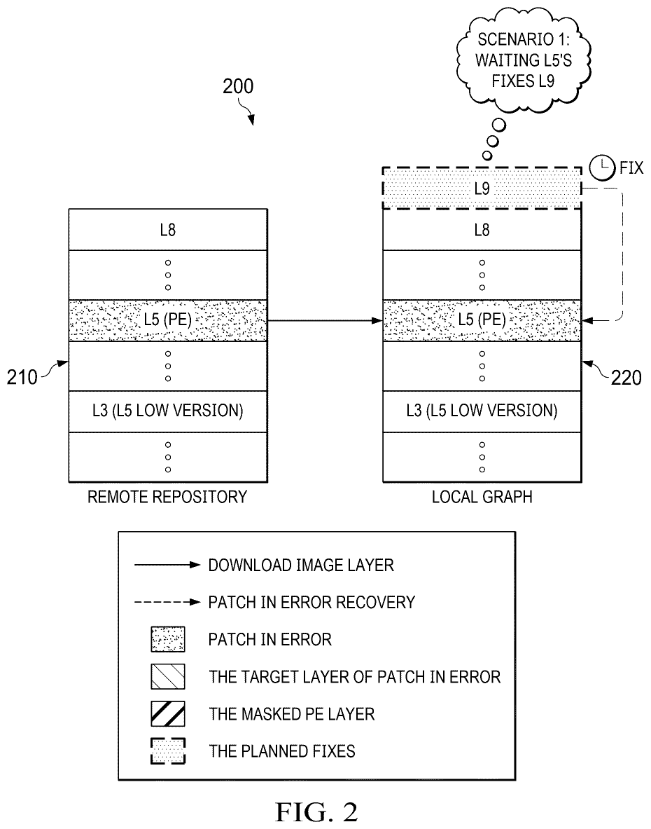

Turning next to FIG. 2, a scenario 1 200 is depicted. Remote repository 210 includes a layer L5 that includes a patch in error. Local graph 220 will eventually receive a layer L9 that provides a planned fix in the future, that may be as far in the future as in the coming several weeks or months, so users have to wait for its availability.

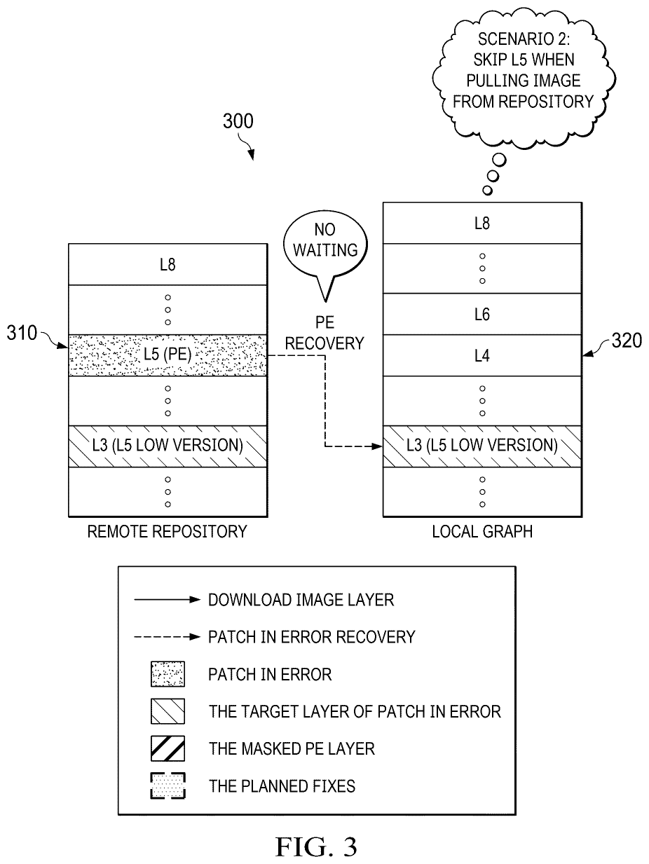

Turning next to FIG. 3, scenario 2 300 is depicted. Remote repository 310 includes layer L5 that includes a patch in error. Local graph 320 skips L5 when pulling images from remote repository 310.

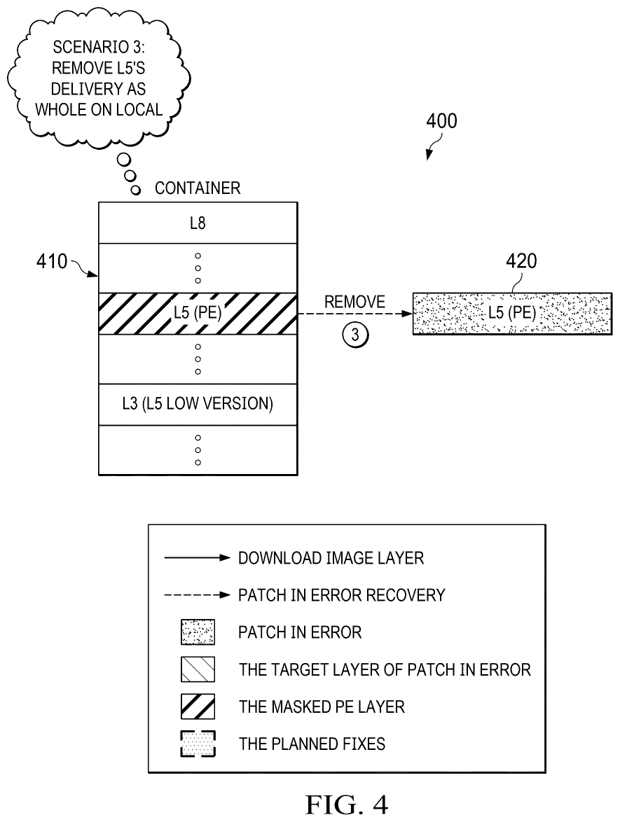

Turning next to FIG. 4, scenario 3 400 is depicted. Container 410 includes layer L5 (PE) 420 that includes patch in error. This scenario is to remove L5's delivery as a whole on the local graph.

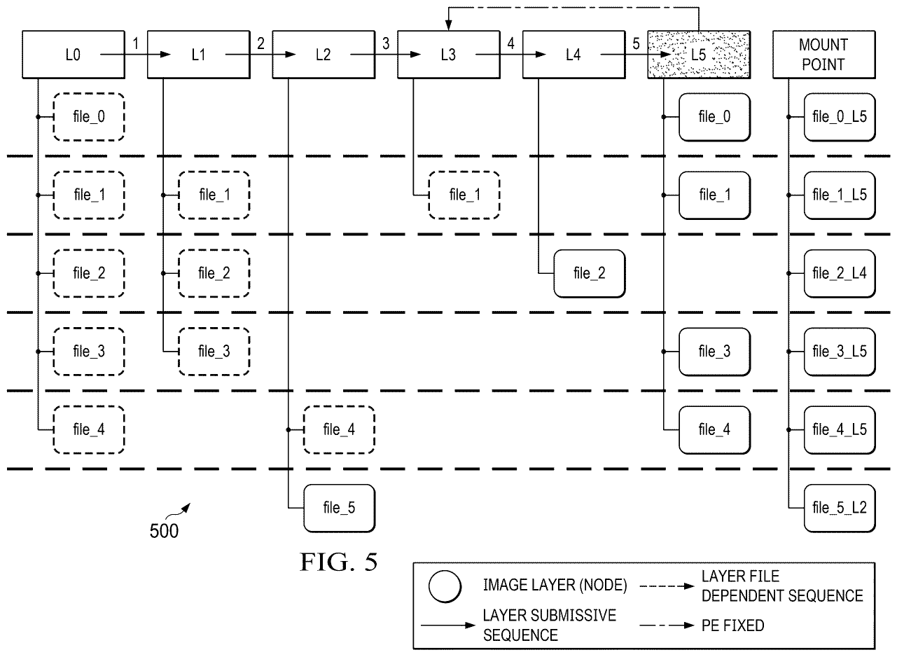

Turning next to FIG. 5, scenario 4 500 includes layers depicted with file level granularity. Based on “Union Mount” rules of the file system on FIG. 3, when users pull L5, the layer with patch in error, there are file_0_L5, file_1_L5, file_2_L4, file_3_L5, file_4_L5 and File_5_L2 on the mount point view, in which file_1 from L5 triggers the error.

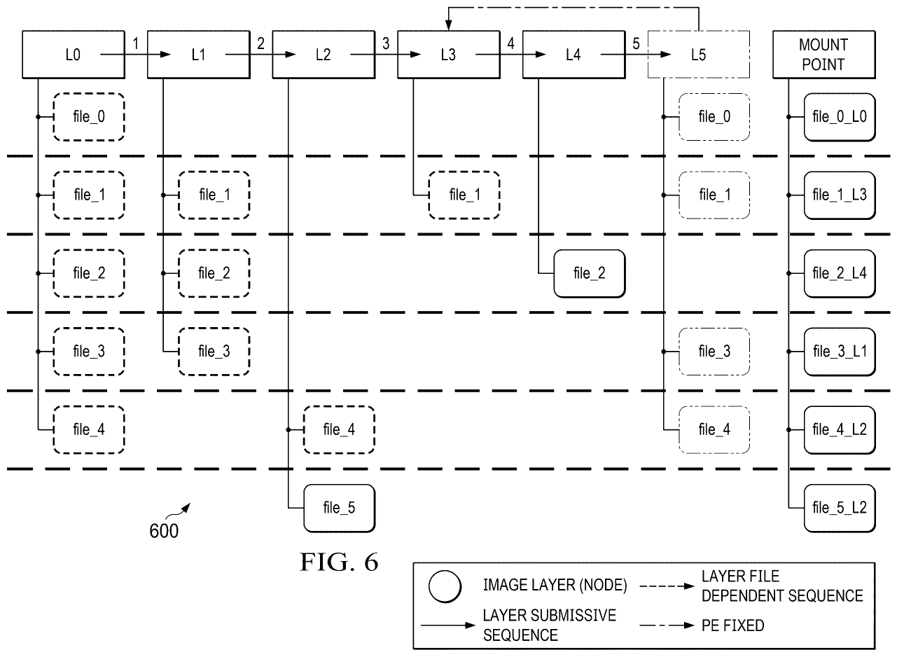

Turning next to FIG. 6, scenario 5 600 includes layers depicted with file level granularity. If the online recovery is done directly for the layer with patch in error (i.e. L5 is the layer with file_1(L5) patch in error), then all of file_0(L5), file_1(L5), file_3(L4), file_4(L5) delivered on L5 will be discarded. In other words, the fixes of L0(file_0), L1(file_3) and L2(file_4) are also removed, it can't recover the fixes on L5 which trigger the error more precisely.

Embodiments of this disclosure include an innovative method to recover the layer with patch in error on local image with file dependencies more precisely by excluding the files which trigger the error and relocating layer cacheID's diff to diff-recovery, to ensure the better use of product capabilities, automation and resiliency insights. The detailed technical approach includes the following.

A new attribute “diff-recovery” is introduced to the low storage level “diff-relocation” under cacheID of the layer to be recovered. The attribute “diff-recovery” is the original storage of the layer with patch in error with the file dependencies.

A new command “recovery layer on dependency” is introduced: layer could be imageID or other layer flag, to invoke OPELRD (Online Patch in Error Layer Recovery on Dependency) module which recovers the layer with patch in error by making directory diff relocated to the diff-recovery sub-folder under local layer's cacheID.

OPELRD (Online Patch in Error Layer Recovery on Dependency) is a module to mask out the content of layer with patch in error more precisely with file dependencies on local graph without waiting for a new fix version on local storage by making diff relocated to the diff-recovery folder. First, get the files delivered as the fixes of patch error (PE) layer according to minimal dependent sub graph. Second, create directory diff-recovery under diff directory of the layer with patch in error and copy the content of diff-recovery to it excluding the files delivered as the fixes of patch error layer according to minimal dependent sub graph. Third, make the layer with patch in error's diff-relocation point to diff-recovery.

Embodiments provide an intelligent and automatic method to ensure the better use of product capabilities, automation and resiliency insights by recovering the layer with patch in error with file dependencies on local image or exploited containers by excluding the files which trigger the error precisely. It can be achieved by introducing a new attribute diff-recovery under cacheID directory and relocating diff-relocation to diff-recovery, to help users promote the robustness of the enterprise-level production environments as soon as possible and avoid the security vulnerability exposure as little as possible.

Embodiments allow users to recover the layer with patch in error on local graph more accurately without waiting a long time for the fixes to be available or redeploy exploited containers on customer's environment especially the product environment. Embodiments are transparent to both the developers of the image and the end users.

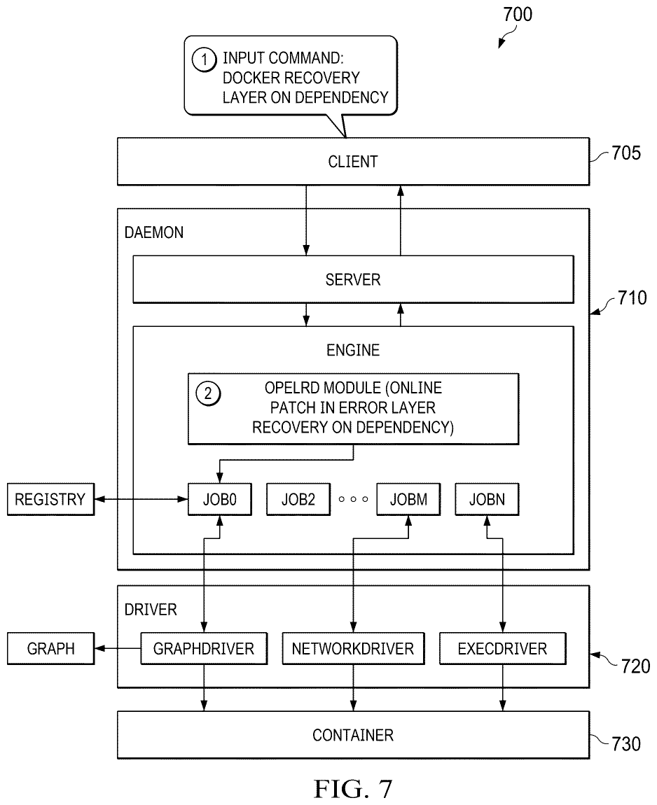

Turning next to FIG. 7, a block diagram of a computer system architecture 700 to recover container layers in error due to dependencies is depicted. Client 705 initiates an input command: recovery layer on dependency. Daemon 710 includes a server and an engine that includes OPELRD module. Driver 720 is coupled to Daemon 710. Container 730 is coupled to Driver 820.

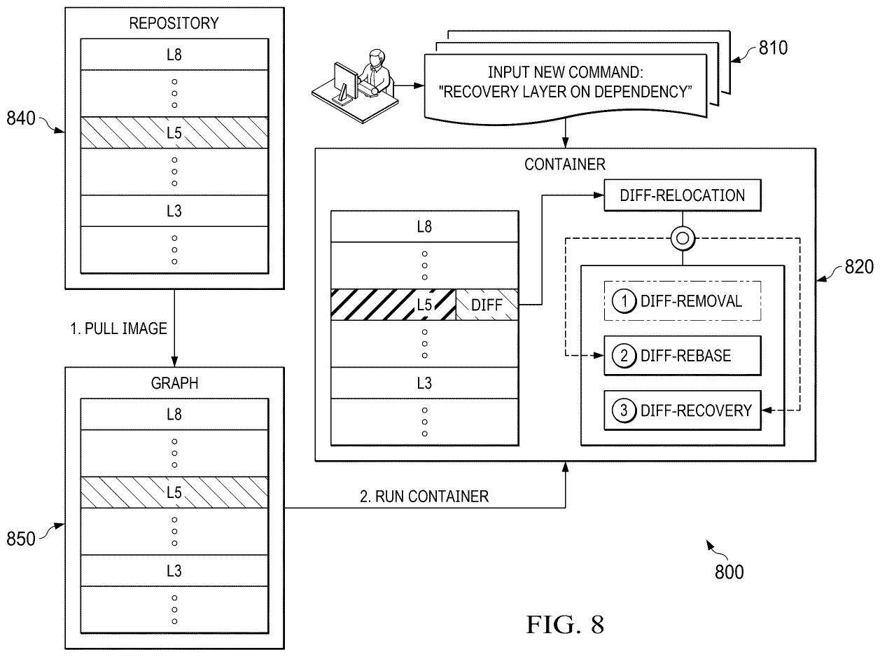

Turning now to FIG. 8, a block diagram of a computer system architecture 800 to recover container layers in error due to dependencies is shown. Client 810 inputs new command: recovery layer on dependency. The new command is sent to container 820. An image is pulled from repository 840 to graph 850. From graph 850, diff-relocation is located (but not actually “run”) at container 820.

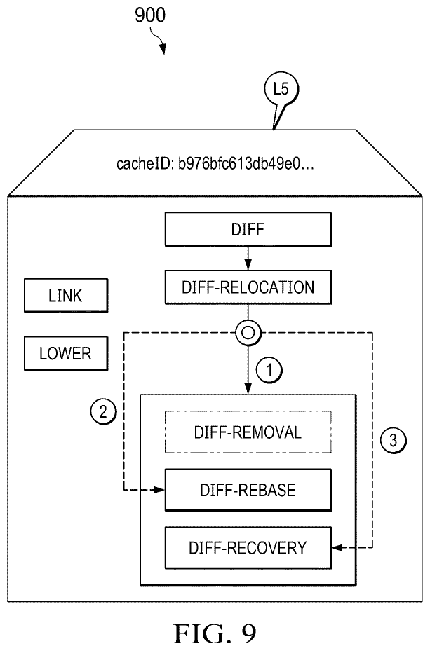

Turning next to FIG. 9, attributes of a layer's cacheID and commands are depicted. Element 900 includes an attribute “diff-recovery” introduced to the low storage level “diff-relocation” under the cacheID. This “diff-recovery” is a more precise recovery collection of the layer with patch in error based on file granularity. Storage level “diff-relocation” includes 2 other attributes: “diff-removal” for the masked layer with a patch in error and “diff-rebase” for the original storage of the layer with the patch in error. The diff-removal attribute is used to mask a layer having a patch in error without waiting for a new fix version of the layer by making diff relocated to the diff-removal folder. The diff-rebase attribute is used to rebase the layer having the patch in error without repulling the layer with the patch in error from a registry or redeploying the container with the layer patch in error by making diff relocated to the diff-rebase folder. Command “recovery layer on dependency” layer can be imageID or other layer flag, to invoke OPELRD module (Online Patch in Error Layer Recovery on Dependency) which will recover the layer with patch in error more precisely by relocating diff-relocation under cacheID folder to the diff-recovery, as (3) in FIG. 9.

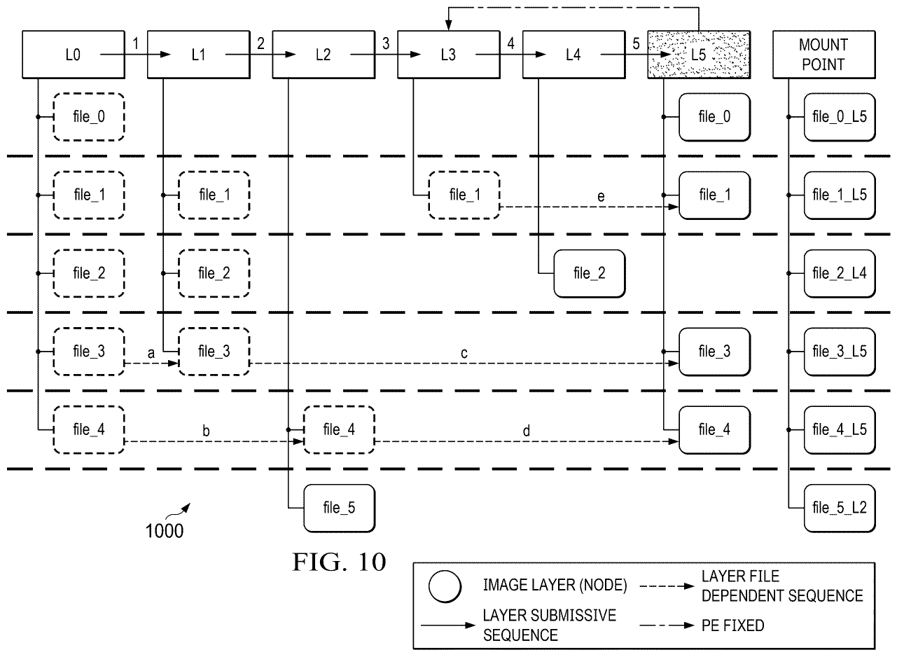

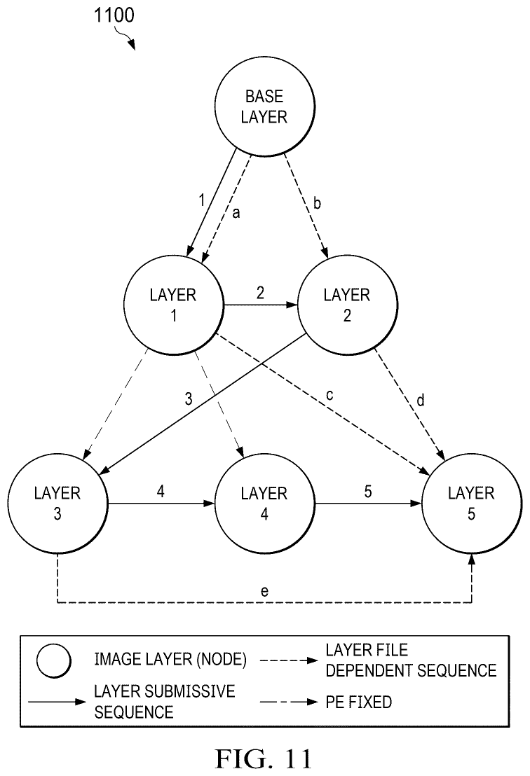

Turning next to FIG. 10, it is the original mount point view before implementing an OPELRD module 1000. Based on “Union Mount” rules of the file system as shown in FIG. 10, there are file_0(L5), file_1(L5), file_2(L4), file_3(L5), file_4(L5) on the mount point view when the user pulls the L5 layer with patch in error. FIG. 11 shows a corresponding minimal dependent sub graph including sequence 1100, where L5 has the file dependencies on L3 & L1 & L2, and file dependencies include c, d, e.

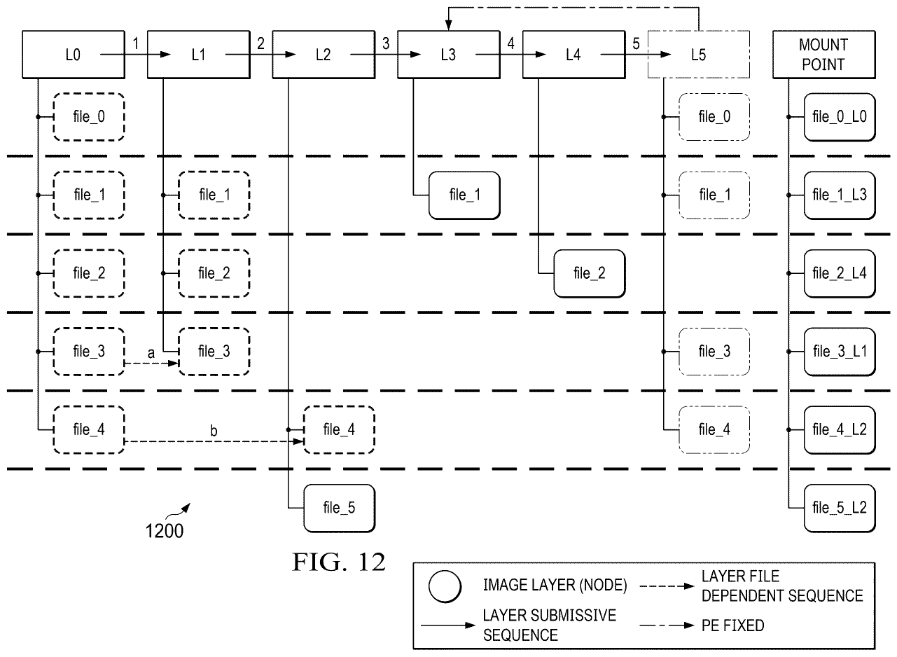

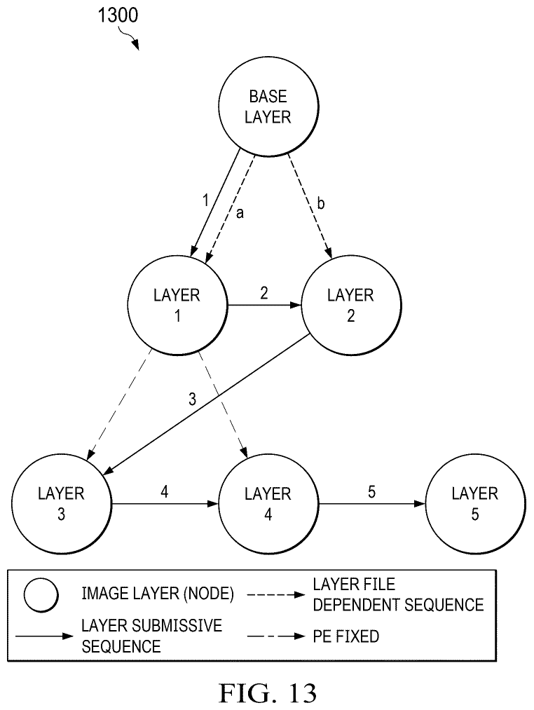

Turning next to FIG. 12, it is the mount point view if recovering the error by removing the whole L5's contents without implementing an OPELRD module 1200. In this embodiment, the recovery is done directly for the layer with patch in error i.e. L5 is the layer with patch in error, then file_0(L5), file_1(L5), file_2(L4), file_4(L5) delivered on L5 will also be discarded. In other words, the fixes of L4, L2 and L1 are also removed if recovery of the patch error is by removing L5's contents as shown in FIG. 12. FIG. 13 shows a corresponding minimal dependent sub graph including sequence 1300.

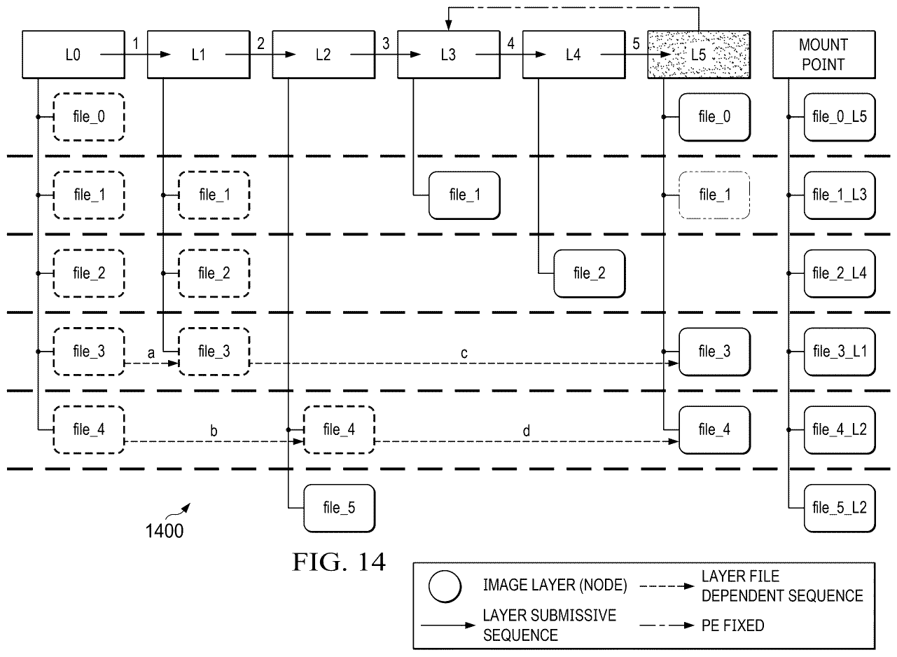

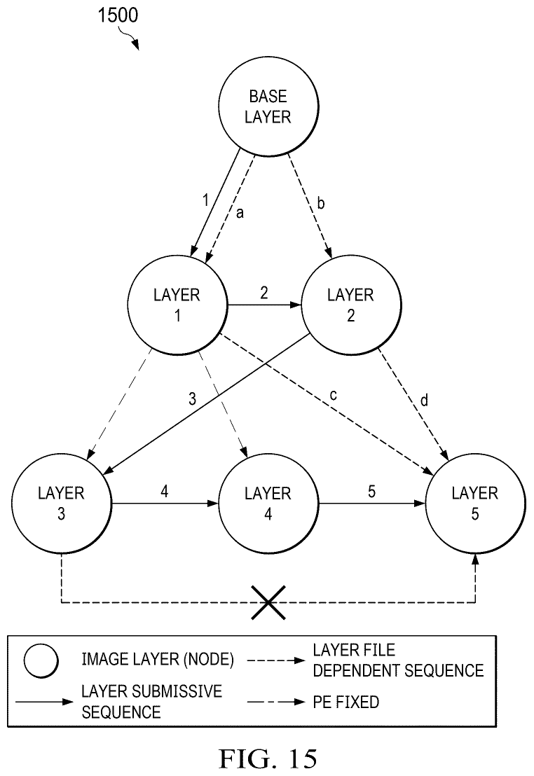

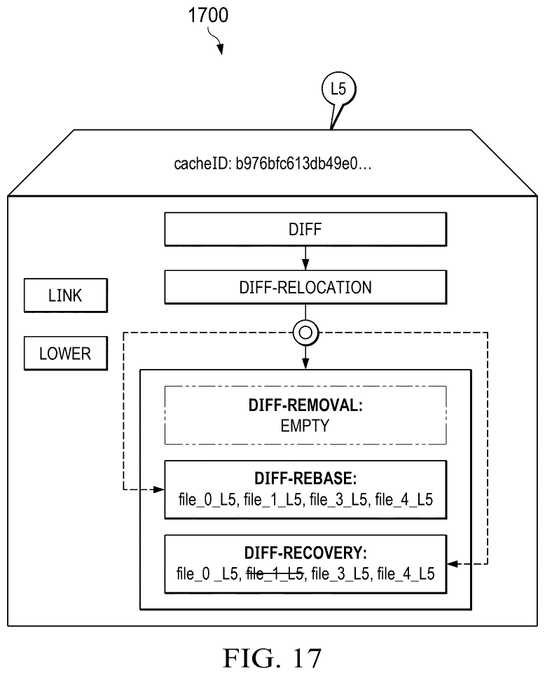

Turning next to FIG. 14, an OPELRD module 1400 is depicted. New mount point view after partial recovery L5 on file dependency is shown in FIG. 14. The minimal dependent sub graph shown in FIG. 15 with sequence 1500 where L5 has the file dependencies on L3 & L1 & L2. Get file_1 has the file dependent on L3, exclude the file_1 from L5 and keep the recovery collection including file_0, file_2, file_3 and file_4 for L5. Finally, copy the recovery collection to diff-recovery under the lower level storage L5's cacheID as shown in FIG. 17. Make diff-relocation point to diff-recovery to achieve the more precise recovery of the layer with patch in error on local. Based on “Union Mount” rules of the file system on FIG. 14, there are file_0(L5), file_1(L3), file_2(L4), file_3(L5), file_4(L5) on the mount point view, which recovery the L5 the layer with patch in error more precisely.

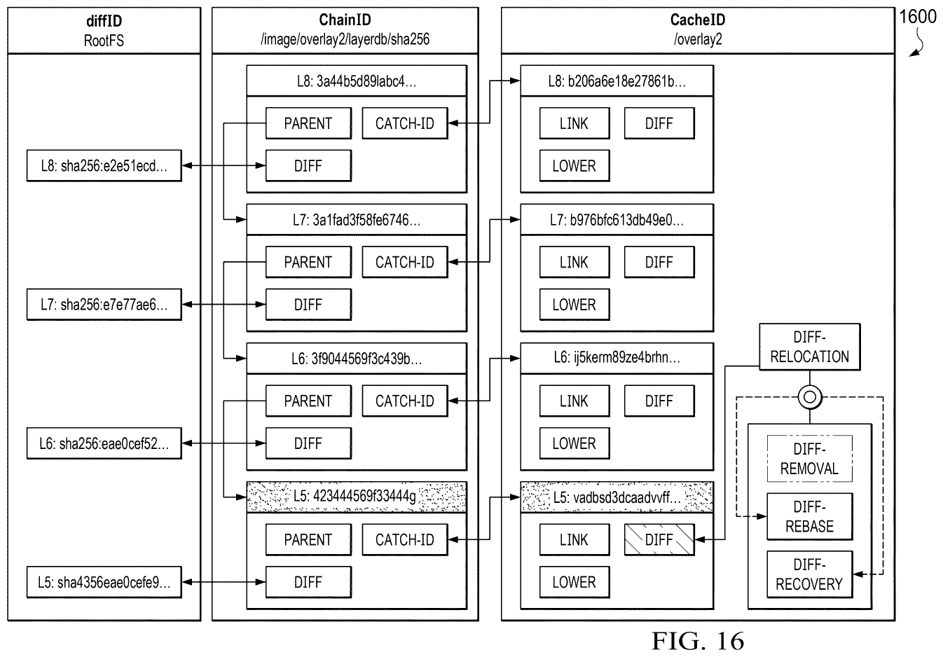

Turning next to FIG. 16, new addressing 1600 of container layers after recovery of L5 (PE) on file dependencies is illustrated. Assuming the context of FIG. 14, File_1 from L5 which triggers the error is excluded. The recovery collection only includes file_0, file_3 and file_4 for L5 as shown in FIG. 14.

Turning next to FIG. 17, directory diff-recovery 1700 under cacheID excluding the files which were dependent on the layer is illustrated. The target of the layer with patch error tried to fix. i.e. just keep file_0_L5, file_3_L5 and file_4_L5 after excluding file_1_L5 which has file dependent on L3 as FIG. 17 shows.

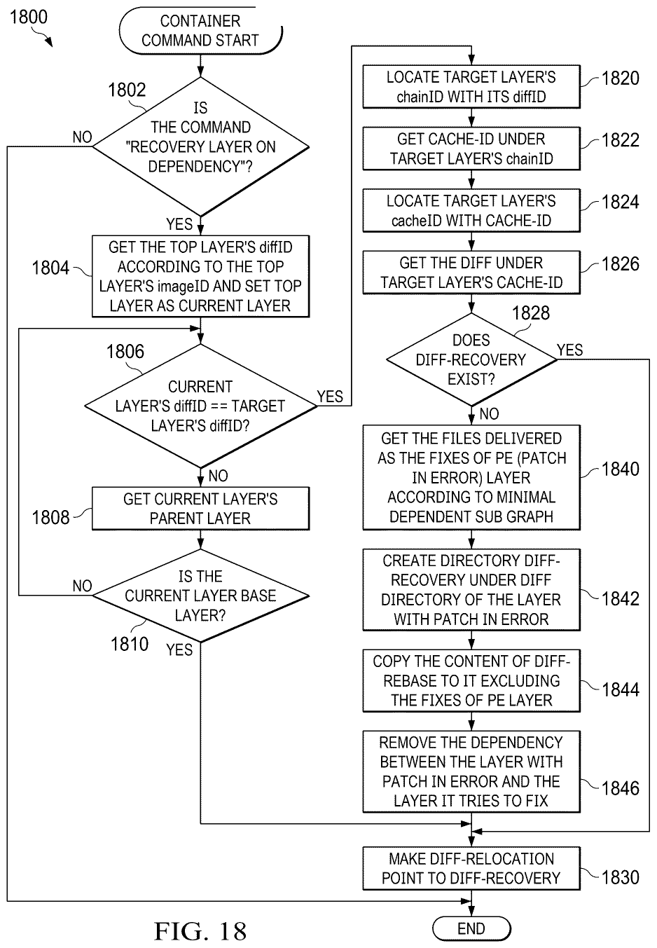

Turning now to FIG. 18, the flow chart depicts an example of a method 1800 for recovering a layer with a patch in error on a local image or on exploited containers with file granularity relocating, rebasing, and recovering. The method 1800 can be performed by any suitable computing system, device, or environment, such as those described herein (e.g., the computing environment 100 and/or the computer 101 of FIG. 1).

The method 1800 begins with the initiation of a container command. At block 1802, the OPELRC engine checks if the command is a “recovery layer on dependency” command. If the command is not a “recovery layer on dependency” command, the method 1800 ends. If the command is a “recovery layer on dependency” command, the method 1800 proceeds to block 1804.

At block 1804, the OPELRC engine retrieves a top layer's diffID according to the top layer's imageID and sets the top layer as the current layer. Then, the top layer's diffID is retrieved according to the top layer's image ID and the top layer is set as the current layer (e.g., target layer is L5 and the top layer is L6). The method 1800 then moves to block 1806.

At block 1806, the OPELRC engine checks if the current layer's diffID is equal to the target layer's diffID. If the diffIDs do not match between the current layer and the target layer, the method 1800 proceeds to block 1808. At block 1808, the OPELRC engine retrieves the current layer's parent layer. The method 1800 then moves to block 1810. At block 1810, the OPELRC engine checks if the current layer is the base layer. If the current layer is the base layer, the method 1800 proceeds to block 1830. If the current layer is not the base layer, the method 1800 returns to block 1806.

If, at block 1806, the diffIDs do match between the current layer and the target layer, the method 1800 moves to block 1820. At block 1820, the OPELRC engine locates the target layer's chainID using the diffID. The method 1800 then moves to block 1822. At block 1822, the OPELRC engine retrieves the cache-id under the target layer's chainID. The method 1800 then moves to block 1824. At block 1824, the OPELRC engine locates the target layer's cacheID using the cache-id. The method 1800 then moves to block 1826. At block 1826, the OPELRC engine retrieves the diff folder under the target layer's cache-id directory. The method 1800 then moves to block 1828.

At block 1828, if the diff-recovery exists, then the method 1800 moves to block 1830. If at block 1828 the diff-recovery does not exist, then the method 1800 moves to block 1840.

At block 1840, the method 1800 gets the files delivered as the fixes of patch error layer according to Minimal Dependent Sub Graph. i.e. file_1 on L5. The method 1800 then moves to block 1842.

At block 1842, the method 1800 creates directory diff-recovery under diff directory of the layer with patch in error. The method 1800 then moves to block 1844.

At block 1844, the method 1800 copies the content of diff-recovery to it excluding the fixes of the layer with patch in error. i.e. file_1 on L5. The method 1800 then moves to block 1846.

At block 1846, the method 1800 removes the dependency between the layer with patch in error and the layer it tries to fix. i.e. dependency between L3 & L5 as shown in FIG. 15. The method 1800 then moves to block 1830.

At block 1830, the method 1800 makes diff-relocation point to diff-recovery as shown in FIG. 17. The method then ends.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

A practical application of an embodiment of the present disclosure that has value within the technological arts is recovery of container layers that are in error due to dependencies. This approach allows users to recover the layer with patch in error on local more accurately without waiting long time for the fixes available or redeploy exploited containers on customer's environment especially the product environment. Both developers and users can easily maintain and upgrade the whole environment without the need for extra work to consider about the negative impact of the patches in error. It is compatible with current container tools, i.e. Docker, Podman, etcetera. There are virtually innumerable uses for embodiments of the present disclosure, all of which need not be detailed here.

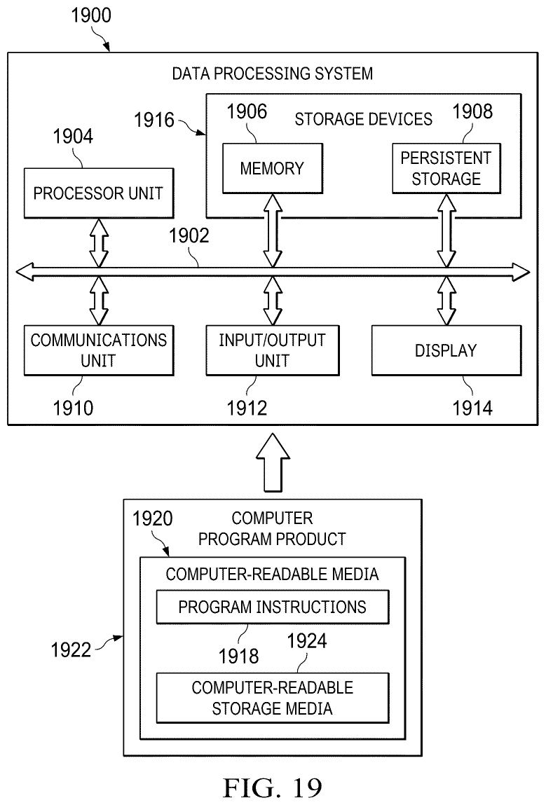

Turning now to FIG. 19, a block diagram of a data processing system is depicted in accordance with an illustrative embodiment. Data processing system 1900 can be used to implement computers and computing devices in computing environment 100 in FIG. 1. In this illustrative example, data processing system 1900 includes communications framework 1902, which provides communications between processor unit 1904, memory 1906, persistent storage 1908, communications unit 1910, input/output (I/O) unit 1912, and display 1914. In this example, communications framework 1902 takes the form of a bus system.

Processor unit 1904 serves to execute instructions for software that can be loaded into memory 1906. Processor unit 1904 includes one or more processors. For example, processor unit 1904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1904 can be implemented using one or more heterogeneous processor systems in which a main processor is present with secondary processors on a single chip. As another illustrative example, processor unit 1904 can be a symmetric multi-processor system containing multiple processors of the same type on a single chip.

Memory 1906 and persistent storage 1908 are examples of storage devices 1916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1916 may also be referred to as computer-readable storage devices in these illustrative examples. Memory 1906, in these examples, can be, for example, a random-access memory or any other suitable volatile or non-volatile storage device. Persistent storage 1908 may take various forms, depending on the particular implementation.

For example, persistent storage 1908 may contain one or more components or devices. For example, persistent storage 1908 can be a hard drive, a solid-state drive (SSD), a flash memory, a rewritable optical disk, a rewritable magnetic tape, or some combination of the above. The media used by persistent storage 1908 also can be removable. For example, a removable hard drive can be used for persistent storage 1908.

Communications unit 1910, in these illustrative examples, provides for communications with other data processing systems or devices. In these illustrative examples, communications unit 1910 is a network interface card.

Input/output unit 1912 allows for input and output of data with other devices that can be connected to data processing system 1900. For example, input/output unit 1912 may provide a connection for user input through at least one of a keyboard, a mouse, or some other suitable input device. Further, input/output unit 1912 may send output to a printer. Display 1914 provides a mechanism to display information to a user.

Instructions for at least one of the operating system, applications, or programs can be located in storage devices 1916, which are in communication with processor unit 1904 through communications framework 1902. The processes of the different embodiments can be performed by processor unit 1904 using computer-implemented instructions, which may be located in a memory, such as memory 1906.

These instructions are referred to as program instructions, computer usable program instructions, or computer-readable program instructions that can be read and executed by a processor in processor unit 1904. The program instructions in the different embodiments can be embodied on different physical or computer-readable storage media, such as memory 1906 or persistent storage 1908.

Program instructions 1918 are located in a functional form on computer-readable media 1920 that is selectively removable and can be loaded onto or transferred to data processing system 1900 for execution by processor unit 1904. Program instructions 1918 and computer-readable media 1920 form computer program product 1922 in these illustrative examples. In the illustrative example, computer-readable media 1920 is computer-readable storage media 1924.

Computer-readable storage media 1924 is a physical or tangible storage device used to store program instructions 1918 rather than a medium that propagates or transmits program instructions 1918. Computer-readable storage media 1924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1918 can be transferred to data processing system 1900 using a computer-readable signal media. The computer-readable signal media are signals and can be, for example, a propagated data signal containing program instructions 1918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, computer-readable media 1920 can be singular or plural. For example, program instructions 1918 can be located in computer-readable media 1920 in the form of a single storage device or system. In another example, program instructions 1918 can be located in computer-readable media 1920 that is distributed in multiple data processing systems. In other words, some instructions in program instructions 1918 can be located in one data processing system while other instructions in program instructions 1918 can be located in one data processing system. For example, a portion of program instructions 1918 can be located in computer-readable media 1920 in a server computer while another portion of program instructions 1918 can be located in computer-readable media 1920 located in a set of client computers.

The different components illustrated for data processing system 1900 are not meant to provide architectural limitations to the manner in which different embodiments can be implemented. In some illustrative examples, one or more of the components may be incorporated in or otherwise form a portion of, another component. For example, memory 1906, or portions thereof, may be incorporated in processor unit 1904 in some illustrative examples. The different illustrative embodiments can be implemented in a data processing system including components in addition to or in place of those illustrated for data processing system 1900. Other components shown in FIG. 19 can be varied from the illustrative examples shown. The different embodiments can be implemented using any hardware device or system capable of running program instructions 1918.

Thus, illustrative embodiments of the present disclosure provide a computer-implemented method, computer system, and computer program product for recovery of container layers that are in error due to dependencies. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
downloading, by a number of processor units, a container image from an image repository;
deploying, by the number of processor units, the container image as a container at a local graph;
identifying, by the number of processor units, an image layer of the container image of the container as having a patch in error layer recovery on dependency; and
performing, by the number of processor units, relocating, rebasing, and recovering the image layer having the patch in error layer recovery on dependency without redeploying the container image at the local graph or restarting a service running the container.

2. The computer-implemented method of claim 1, wherein recovering the image layer comprises excluding only a file that triggers the patch in error layer recovery on dependence, the file located in the image layer having the patch in error layer recovery on dependency.

3. The computer-implemented method of claim 1, wherein rebasing the image layer comprises restoring an original version of the image layer having the patch in error layer recovery on dependency.

4. The computer-implemented method of claim 1, wherein performing comprises relocating a difference property for the image layer having the patch in error layer recovery on dependency to a diff-removal folder, which causes the image layer having the patch in error layer recovery on dependency to be masked.

5. The computer-implemented method of claim 1, wherein rebasing the image layer comprises relocating a difference property to a diff-rebase folder, which identifies an original version of the image layer having the patch in error layer recovery on dependency to be restored.

6. The computer-implemented method of claim 1, wherein the recovering is performed responsive to receiving a recovery layer command.

7. The computer-implemented method of claim 1, wherein the rebasing is performed responsive to receiving a rebase layer command.

8. A computer system comprising:
a processor set;
a set of one or more computer-readable storage media;
program instructions, collectively stored in the set of one or more storage media, for causing the processor set to perform the following computer operations:
downloading, by a number of processor units, a container image from an image repository;
deploying, by the number of processor units, the container image as a container at a local graph;
identifying, by the number of processor units, an image layer of the container image of the container as having a patch in error layer recovery on dependency; and
performing, by the number of processor units, relocating, rebasing, and recovering the image layer having the patch in error layer recovery on dependency without redeploying the container image at the local graph or restarting a service running the container.

9. The computer system of claim 8, wherein recovering the image layer comprises excluding only a file that triggers the patch in error layer recovery on dependence, the file located in the image layer having the patch in error layer recovery on dependency.

10. The computer system of claim 8, wherein rebasing the image layer comprises restoring an original version of the image layer having the patch in error layer recovery on dependency.

11. The computer system of claim 8, wherein performing comprises relocating a difference property for the image layer having the patch in error layer recovery on dependency to a diff-removal folder, which causes the image layer having the patch in error layer recovery on dependency to be masked.

12. The computer system of claim 8, wherein rebasing the image layer comprises relocating a difference property to a diff-rebase folder, which identifies an original version of the image layer having the patch in error layer recovery on dependency to be restored.

13. The computer system of claim 8, wherein the recovering is performed responsive to receiving a recovery layer command.

14. The computer system of claim 8, wherein the rebasing is performed responsive to receiving a rebase layer command.

15. A computer program product comprising:
a set of one or more computer-readable storage media; and
program instructions, collectively stored in the set of one or more storage media, for causing a processor set to perform the following computer operations:
downloading, by a number of processor units, a container image from an image repository;
deploying, by the number of processor units, the container image as a container at a local graph;
identifying, by the number of processor units, an image layer of the container image of the container as having a patch in error layer recovery on dependency; and
performing, by the number of processor units, relocating, rebasing, and recovering the image layer having the patch in error layer recovery on dependency without redeploying the container image at the local graph or restarting a service running the container.

16. The computer program product of claim 15, wherein recovering the image layer comprises excluding only a file that triggers the patch in error layer recovery on dependence, the file located in the image layer having the patch in error layer recovery on dependency.

17. The computer program product of claim 15, wherein rebasing the image layer comprises restoring an original version of the image layer having the patch in error layer recovery on dependency.

18. The computer program product of claim 15, wherein performing comprises relocating a difference property for the image layer having the patch in error layer recovery on dependency to a diff-removal folder, which causes the image layer having the patch in error layer recovery on dependency to be masked.

19. The computer program product of claim 15, wherein rebasing the image layer comprises relocating a difference property to a diff-rebase folder, which identifies an original version of the image layer having the patch in error layer recovery on dependency to be restored.

20. The computer program product of claim 15, wherein recovering is performed responsive to receiving a recovery layer command.
